(19) United States
(12) Patent Application Publication
(10) Pub. No.: US 2026/0163965 A1
(43) Pub. Date: Jun. 11, 2026

(54) METHOD FOR PROTOCOL STACK LOGS ANALYSIS

(71) Applicant: Rohde & Schwarz GmbH & Co. KG, Muenchen (DE)

(72) Inventor: Nalin GUPTA, Fleet (GB)

(21) Appl. No.: 18/975,663

(22) Filed: Dec. 10, 2024

(51) Int. Cl. H04L 69/18; H04L 69/30

(52) U.S. Cl. CPC H04L 69/18; H04L 69/30

(57) ABSTRACT

A method for protocol stack logs analysis is described. The method includes the steps of exchanging data between at least two communication devices by using a protocol stack including a plurality of protocol layers; logging messages that relate to the data exchange to a file, wherein the messages are provided with unique identifiers; and linking related messages to each other by using the unique identifiers of the logged messages, wherein messages are linked to each other that concern protocol data units (PDUs) that are transmitted or received by a protocol layer of the protocol stack and that pertain to a specific instance of a communication procedure.

### FIELD OF THE DISCLOSURE

Embodiments of the present disclosure generally relates to a method for protocol stack logs analysis. Embodiments of the present disclosure also relate to a non-transitory computer-readable medium.

### BACKGROUND

In many communication applications, protocol stacks including multiple protocol layers are used. Each participating communication device runs an instance of the protocol stack. Protocol data units, PDUs, relate to single units of information which are exchanged among peer layers, i.e. protocol layers of the same level running on different peer entities of a computer network, namely the different communication devices.

For analyzing and verifying the functionality of a protocol stack, events occurring at the different protocol layers are logged to a file. Analysis of the resulting protocol stack logs is a complex task and typically requires a deep expertise in the used protocols. This however makes the analysis complicated and time-consuming. In fact, the analysis can only be done by experts.

Accordingly, there is a need for making the analysis of protocol stack logs simpler.

### SUMMARY

The following summary of the present disclosure is intended to introduce different concepts in a simplified form that are described in further detail in the detailed description provided below. This summary is neither intended to denote essential features of the present disclosure nor shall this summary be used as an aid in determining the scope of the claimed subject matter.

The present disclosure provides examples of a method for protocol stack logs analysis. In an embodiment, the method comprises the steps of: exchanging data between at least two communication devices by using a protocol stack comprising a plurality of protocol layers; logging messages that relate to the data exchange to a file, wherein the messages are provided with unique identifiers; and linking related messages to each other by using the unique identifiers of the logged messages. The messages may be linked, for example, to each other that concern protocol data units (PDUs) that are transmitted or received by a protocol layer of the protocol stack and that pertain to a specific instance of a communication procedure.

Accordingly, messages that are related can be identified easily, since the method links the messages to each other. Thus, analysis of the protocol stack logs is simplified and can be performed without deep expertise in the used communication protocols. More specifically, messages that pertain to a specific instance of a communication procedure are linked to each other. Determining which messages of a protocol log constitute a complete instance of a communication procedure is typically a very complex task. By linking the corresponding messages to each other, the disclosed methods reduce the complexity of this task substantially.

In an embodiment, the linked messages can be outputted for example as a chain. Thus, besides making it easy to discern which messages are related, the messages can be provided in a specific order. For example, the messages in the chain can be ordered chronologically or according to their functional (especially causal) relationship to each other.

As a more specific example, the linked messages that concern the protocol data units may be displayed as a horizontal chain. The messages can thus be displayed in a manner that promotes intuitive understanding, since the protocol data units are transmitted or received by a specific protocol layer that is located at a specific horizontal level within the protocol stack.

An additional option is that messages can be linked to each other that pertain to a service data unit being handed over between neighboring protocol layers of the protocol stack such that the service data unit can traverse the protocol stack. Hence, messages that are related, because they pertain to a service data unit traversing the protocol stack, can be identified easily, since they have been linked to each other. Analysis of the protocol stack logs is thus simplified further.

In an embodiment, the linked messages that concern the service data unit may be displayed as a vertical chain. The messages are thus displayed in an intuitively understandable manner since they relate to a service data unit that traverses the protocol stack in a vertical direction.

In an embodiment, abstract service primitives identifiers may be used for linking the messages that pertain to the service data unit being handed over between neighboring protocol layers of the protocol stack.

When different layers of a protocol stack communicate with each other regarding a service that is to be carried out by one of the layers, they exchange messages that can be referred to as abstract service primitives. Typically, there are four types of abstract service primitives: request, indication, response, and confirmation. Hence, protocol layers can use abstract primitives for example to request a service from another layer, indicate that an event has occurred, respond to a request, and/or confirm that a response has been acknowledged.

According to an aspect of the present disclosure, all messages received, for example, may displayed in a certain order irrespective of any linkage. In an embodiment, a user is enabled to select a certain message of all messages displayed in order to identify the neighboring protocol layers associated with the certain message.

In other words, the user can be presented with an overview of logged messages and obtain information about messages that are related to a certain message by simply selecting that message. The user can thus acquire the information without needing a deep expertise in the used communication protocols.

As one implementation, a context menu may be displayed when selecting the certain message. Hence, the user is enabled to make a detailed choice about which information is to be displayed. More specifically, the user can be enabled to choose which type of message that is related to the selected message is to be displayed. Displaying the context menu may be triggered via an appropriate user input for triggering a secondary action.

In the context of the present disclosure, examples of an appropriate user input for triggering a secondary action include a click with a secondary mouse button (e.g. a right mouse button), a long press on a touch screen (e.g. longer than 0.5, 1.0, or 1.5 seconds), or a two-finger tap on a touchpad. Other techniques are envisioned to be within the scope of the claimed subject matter.

For example, the context menu may provide selectable items associated with the previous protocol layer of the certain message and the subsequent protocol layer of the certain message. Accordingly, the user can be enabled to navigate back and forth between causally linked messages without requiring a deep understanding of the used communication protocols to do so.

Generally, any communication procedure according to the protocols of the used protocol stack can be suitable for the specific instance of the communication procedure referred to above. To give an example, the specific instance of the communication procedure may correspond to a transmission of a message to one of the communication devices via a Short Message Service. Hence, all logged messages that are associated with the transmission of the message can be identified easily.

As an implementation option, the logged messages may be provided with a PDU-chain field, wherein the PDU-chain field of each logged message that is to be linked with a specific logged message is filled in with the unique identifier of the specific logged message. Accordingly, the related messages can be linked in a very simple and reliable way.

According to another aspect of the present disclosure, all messages received, for example, may be displayed in a certain order irrespective of any linkage, wherein a user is enabled to select a certain message of all messages displayed in order to identify the protocol data units, PDUs, that pertain to the specific instance of the communication procedure. Hence, even users with limited knowledge about the communication protocols of the protocol stack can easily find out which messages relate to the specific instance of the communication procedure.

In an embodiment, a context menu may be displayed when selecting the certain message. For example, displaying the context menu may be triggered via an appropriate user input for triggering a secondary action (e.g. via a right click).

In an embodiment, the context menu may provide selectable items associated with the previous protocol data unit of the certain message and the subsequent protocol data unit of the certain message. Accordingly, a user can be enabled to navigate easily between messages that relate to the specific instance of the communication procedure.

In another embodiment, the messages may be linked to each other that pertain to a service data unit being handed over between neighboring protocol layers of the protocol stack such that the service data unit can traverse the protocol stack and the context menu may also provide selectable items associated with a previous protocol layer of the certain message and the subsequent protocol layer of the certain message. Hence, the context menu allows the user to navigate to causally linked messages concerning neighboring protocol layers as well as to messages that are related because they pertain to the specific instance of the communication procedure. The user is thus enabled to investigate relationships between the logged messages in multiple dimensions without requiring deep knowledge about the underlying protocol stack.

The present disclosure further provides examples of a non-transitory computer-readable medium storing instructions that, when executed by an electronic circuit, a processor, etc., cause the electronic circuit, the processor, etc., to perform a method that comprises: exchanging data by using a protocol stack comprising a plurality of protocol layers; logging messages that relate to the data exchange to a file, wherein the messages are provided with unique identifiers; and linking related messages to each other by using the unique identifiers of the logged messages. In an embodiment, the messages are linked to each other that concern protocol data units (PDUs) that are transmitted or received by a protocol layer of the protocol stack and that pertain to a specific instance of a communication procedure.

Features and advantages described above regarding the method for protocol stack logs analysis also apply to the non-transitory computer-readable medium.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically depicts two communication devices exchanging data in the context of a method for protocol stack logs analysis according to an embodiment of the present disclosure;

FIG. 2 is a block diagram schematically illustrating aspects of the method for protocol stack logs analysis according to an embodiment of the present disclosure;

FIG. 3 is an example of a table representing a protocol stack log according to an embodiment of the present disclosure;

FIG. 4 shows example messages of a protocol stack log according to an embodiment of the present disclosure outputted as a chain;

FIG. 5 is an alternative view of the protocol stack log of FIG. 3, illustrating context menu functionality; and

FIG. 6 schematically shows a non-transitory computer-readable medium according to an embodiment of the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

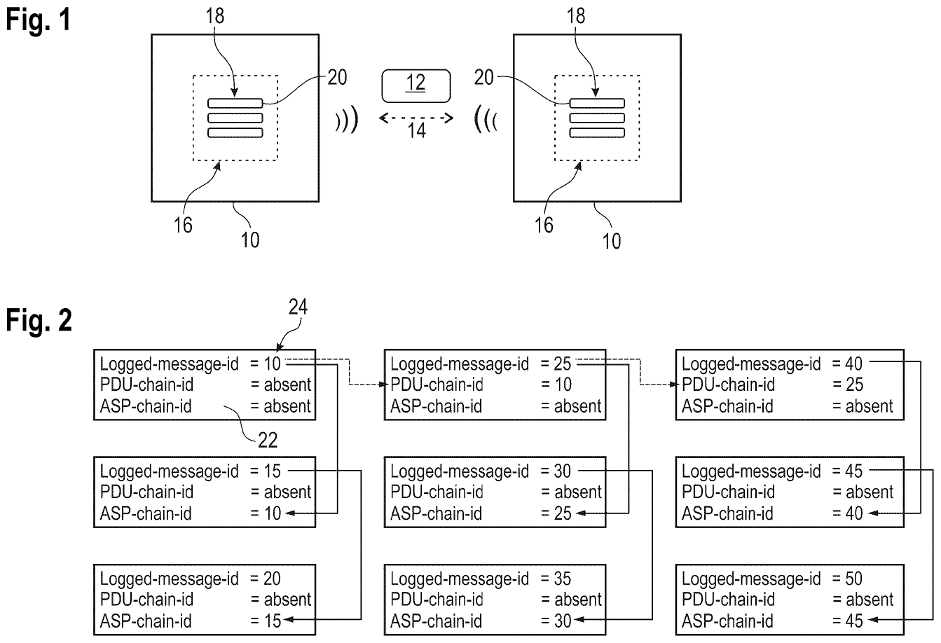

FIG. 1 schematically depicts two communication devices 10 exchanging data 12 in the context of a method for protocol stack logs analysis. In this example, the data exchange is performed via a wireless connection 14.

Each of the communication devices 10 comprises an electronic circuit 16 running a protocol stack 18 comprising a plurality of protocol layers 20. In an embodiment, the protocol layers 20 comprise communication protocols, especially wireless communication protocols. The respective protocol stack 18 is used for exchanging the data 12 between the communication devices 10.

Messages 22 that relate to the data exchange are provided with unique identifiers 24, as illustrated in FIG. 2. In the depicted example, the unique identifiers 24 are referred to as “logged-message-id”.

The unique identifiers 24 are used to link related messages 22 to each other that concern protocol data units that are transmitted or received by a protocol layer 20 of the protocol stack 18 and that pertain to a specific instance of a communication procedure. For this purpose, the logged messages 22 are provided with a PDU-chain field. In the example depicted in FIG. 2, the PDU-chain field is referred to as “PDU-chain-id”. The PDU-chain field of each logged message 22 that is to be linked with a specific logged message 22 is filled in with the unique identifier 24 of the specific logged message 22.

Similarly, the unique identifiers 24 are used to link messages 22 to each other that pertain to a service data unit being handed over between neighboring protocol layers 20 of the protocol stack 18 such that the service data unit can traverse the protocol stack 18. For this purpose, the logged messages 22 are provided with a SDU-chain field. For instance, abstract service primitives (ASP) identifiers may be used for linking the messages 22 that pertain to the service data unit. Therefore, the SDU-chain field is referred to as “ASP-chain-ID” in the example shown in FIG. 2.

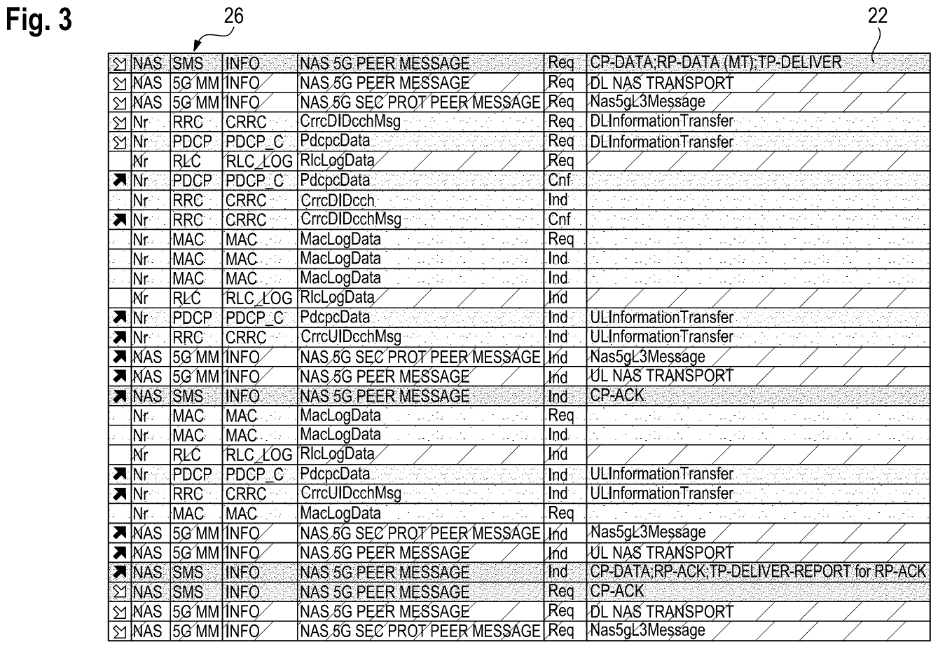

FIG. 3 is an example of a table representing a file that the messages 22 are logged to. Related messages 22 have been linked to each other as described above and can thus be identified easily. For example, messages indicated as “SMS” in the third column 26 of the table can be identified as pertaining to a message transmission via a Short Message Service.

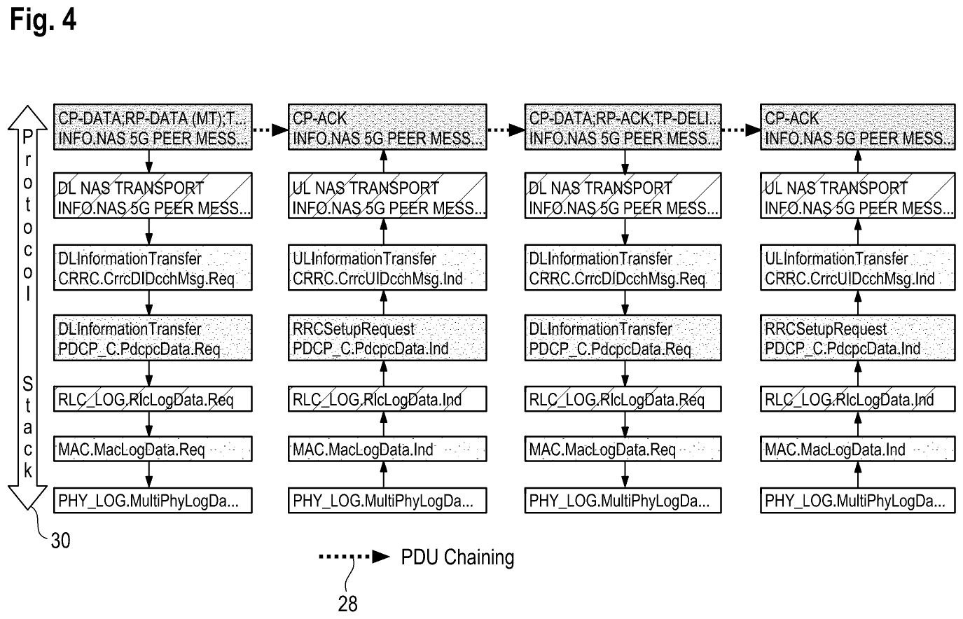

As illustrated in FIG. 4, the linked messages 22 can be outputted as a chain. In the depicted example, linked messages 22 that concern the protocol data units are displayed as a horizontal chain 28 and linked messages 22 that concern the service data unit are displayed as a vertical chain 30. For example, the messages pertaining to the transmission via the Short Message Service are provided next to each other in the uppermost horizontal chain and can thus be discerned even more readily.

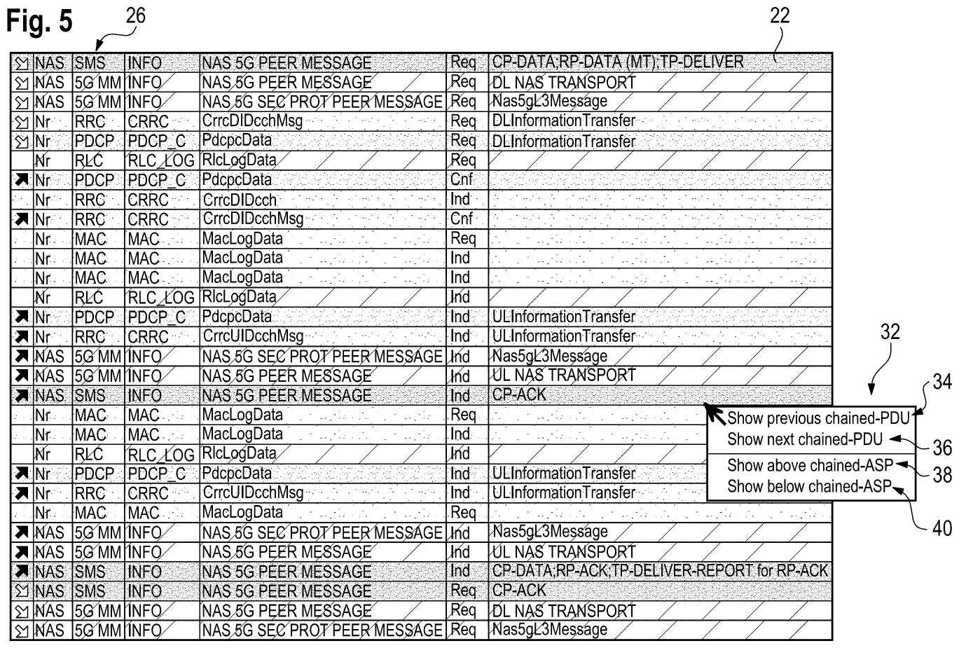

FIG. 5 is another view of the table shown in FIG. 3. As illustrated in FIG. 5, a context menu 32 is displayed when selecting a certain message of all messages 22 displayed. The context menu 32 provides selectable items associated with the previous protocol data unit 34 of the certain message and the subsequent protocol data unit 36 of the certain message. Hence, a user can navigate easily between messages that relate to the specific instance of the communication procedure.

In addition, the context menu 32 also provides selectable items associated with a previous protocol layer 38 of the certain message and a subsequent protocol layer 40 of the certain message. Hence, the context menu 32 allows the user to navigate to causally linked messages pertaining to neighboring protocol layers. The messages referred to here as causally linked pertain to a service data unit traversing the protocol stack 18 by being handed over between neighboring layers of the protocol stack 18.

Typically, a header (and/or footer) is added to the service data unit when being passed down to a lower layer. In the other direction, the header added by the lower layer is removed when the service data unit is passed up to a higher layer. The combination of header and serviced data unit is typically referred to as protocol data unit.

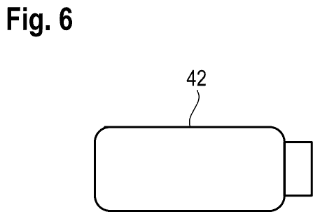

FIG. 6 schematically shows a non-transitory computer-readable medium 42. In an embodiment, the depicted non-transitory computer-readable medium 42 is a flash drive that can be connected to a Universal Serial Bus (USB) interface. The non-transitory computer-readable medium 42 stores instructions that can be executed, for example, by the electronic circuit 16 of one of the communication devices 10 depicted in FIG. 1.

When executed by the electronic circuit 16, the instructions cause the electronic circuit 16 to perform a method that comprises exchanging data 12 by using a protocol stack 18 comprising a plurality of protocol layers 20. The method further comprises logging messages 22 that relate to the data exchange to a file. The messages 22 are provided with unique identifiers 24. In addition, the method comprises linking related messages 22 to each other by using the unique identifiers 24 of the logged messages 22. The messages 22 are linked to each other that concern protocol data units, PDUs, that are transmitted or received by a protocol layer 20 of the protocol stack 18 and that pertain to a specific instance of a communication procedure.

In the context of the present disclosure, non-transitory computer-readable media comprise all computer-readable media with the sole exception being a transitory, propagating signal. Examples of suitable computer-readable media include read-only memory (ROM), electrically erasable programmable read-only memory (EEPROM), flash memory, random-access memory (RAM), hard disk drive (HDD), solid-state drive (SSD), flash drive, and optical disc (e.g. CD, DVD, and Blu-ray disc).

Certain embodiments disclosed herein include systems, apparatus, modules, units, devices, components, etc., that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a graphics processing unit (GPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof. In an embodiment, circuitry includes hardware circuit implementations (e.g., implementations in analog circuitry, implementations in digital circuitry, and the like, and combinations thereof).

In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

For example, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implementing the functionality described herein.

Of course, in an embodiment, two or more of these components, or parts thereof, can be integrated or share hardware and/or software, circuitry, etc. In an embodiment, these components, or parts thereof, may be grouped in a single location or distributed over a wide area. In circumstances where the components are distributed, the components are accessible to each other via communication links.

In an embodiment, one or more of the components of the communication devices 10, etc., referenced above include circuitry programmed to carry out one or more steps of any of the methods disclosed or claimed herein. In an embodiment, one or more computer-readable media associated with or accessible by such circuitry contains computer readable instructions embodied thereon that, when executed by such circuitry, cause the component or circuity to perform one or more steps of any of the methods disclosed or claimed herein.

In an embodiment, the computer readable instructions includes applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably).

In an embodiment, computer-readable media is any medium that stores computer readable instructions, or other information non-transitorily and is directly or indirectly accessible by a computing device, such as processor circuitry, etc., or other circuity disclosed herein etc. In other words, a computer-readable medium is a non-transitory memory at which one or more computing devices can access instructions, codes, data, or other information. In addition to or in the alternate to the examples set forth above, as a non-limiting example, a computer-readable medium may include a volatile random access memory (RAM), a persistent data store such as a hard disk drive or a solid-state drive, or a combination thereof. In an embodiment, memory can be integrated with a processor, separate from a processor, or external to a computing system.

Accordingly, blocks of the block diagrams and/or flowchart illustrations support various combinations for performing the specified functions, combinations of operations for performing the specified functions and program instructions for performing the specified functions. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein. Again, it should also be understood that each block of the block diagrams and flowchart illustrations, and combinations of blocks in the block diagrams and/or flowchart illustrations, or portions thereof, could be implemented by special purpose hardware-based computer systems or circuits, etc., that perform the specified functions or operations, or combinations of special purpose hardware and computer instructions.

It will be appreciated that in one or more embodiments, the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), a graphics processing unit (GPU) or the like, or any combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

Although the method and various embodiments thereof have been described as performing sequential steps, the claimed subject matter is not intended to be so limited. As nonlimiting examples, the described steps need not be performed in the described sequence and/or not all steps are required to perform the method. Moreover, embodiments are contemplated in which various steps are performed in parallel, in series, and/or a combination thereof. As such, one of ordinary skill will appreciate that such examples are within the scope of the claimed embodiments.

In the detailed description herein, references to “one embodiment”, “an embodiment”, “an example embodiment”, “one or more embodiments”, “some embodiments”, etc., indicate that the embodiment or embodiments described may include a particular feature, structure, or characteristic, but every embodiment may not necessarily include the particular feature, structure, or characteristic. Moreover, such phrases are not necessarily referring to the same embodiment or embodiments. In addition, when a particular feature, structure, or characteristic is described in connection with an embodiment or embodiments, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A method for protocol stack logs analysis, the method comprising the steps of:
exchanging data between at least two communication devices by using a protocol stack comprising a plurality of protocol layers;
logging messages that relate to the data exchange to a file, wherein the messages are provided with unique identifiers; and
linking related messages to each other by using the unique identifiers of the logged messages, wherein messages are linked to each other that concern protocol data units, PDUs, that are transmitted or received by a protocol layer of the protocol stack and that pertain to a specific instance of a communication procedure.

2. The method according to claim 1, wherein the linked messages are outputted as a chain.

3. The method according to claim 1, wherein the linked messages that concern the protocol data units are displayed as a horizontal chain.

4. The method according to claim 1, wherein messages are linked to each other that pertain to a service data unit being handed over between neighboring protocol layers of the protocol stack such that the service data unit can traverse the protocol stack.

5. The method according to claim 4, wherein the linked messages that concern the service data unit are displayed as a vertical chain.

6. The method according to claim 4, wherein abstract service primitives identifiers are used for linking the messages that pertain to the service data unit being handed over between neighboring protocol layers of the protocol stack.

7. The method according to claim 4, wherein all messages received are displayed in a certain order irrespective of any linkage, and wherein a user is enabled to select a certain message of all messages displayed in order to identify the neighboring protocol layers associated with the certain message.

8. The method according to claim 7, wherein a context menu is displayed when selecting the certain message.

9. The method according to claim 8, wherein the context menu provides selectable items associated with the previous protocol layer of the certain message and the subsequent protocol layer of the certain message.

10. The method according to claim 1, wherein the specific instance of the communication procedure corresponds to a transmission of a message to one of the communication devices via a Short Message Service.

11. The method according to claim 1, wherein the logged messages are provided with a PDU-chain field, and wherein the PDU-chain field of each logged message that is to be linked with a specific logged message is filled in with the unique identifier of the specific logged message.

12. The method according to claim 1, wherein all messages received are displayed in a certain order irrespective of any linkage, and wherein a user is enabled to select a certain message of all messages displayed in order to identify the protocol data units, PDUs, that pertain to the specific instance of the communication procedure.

13. The method according to claim 12, wherein a context menu is displayed when selecting the certain message.

14. The method according to claim 13, wherein the context menu provides selectable items associated with the previous protocol data unit of the certain message and the subsequent protocol data unit of the certain message.

15. The method according to claim 14, wherein the messages are linked to each other that pertain to a service data unit being handed over between neighboring protocol layers of the protocol stack such that the service data unit can traverse the protocol stack, and wherein the context menu also provides selectable items associated with a previous protocol layer of the certain message and the subsequent protocol layer of the certain message.

16. A non-transitory computer-readable medium storing instructions that, when executed by an electronic circuit or computing device, cause the electronic circuit or computing device to perform a method comprising:
exchanging data by using a protocol stack comprising a plurality of protocol layers;
logging messages that relate to the data exchange to a file, wherein the messages are provided with unique identifiers; and
linking related messages to each other by using the unique identifiers of the logged messages, wherein messages are linked to each other that concern protocol data units, PDUs, that are transmitted or received by a protocol layer of the protocol stack and that pertain to a specific instance of a communication procedure.
